(19) United States
(12) Patent Application Publication
(10) Pub. No.: US 2019/0068248 A1
(43) Pub. Date: Feb. 28, 2019

(54) Transmission Apparatus, Antenna Drive Apparatus, Tuning Method, and Program for Realizing Tuning Method

(71) Applicant: DEXERIALS CORPORATION, Tokyo (JP)

(72) Inventor: Masayoshi KANNO, Tokyo (JP)

(73) Assignee: Dexerials Corporation, Tokyo (JP)

(21) Appl. No.: 16/079,479

(22) PCT Filed: Mar. 22, 2017
(86) PCT No.: PCT/JP2017/011406

§ 371 Date: Aug. 23, 2018

(30) Foreign Application Priority Data
Mar. 24, 2016 (JP) 2016-059796

(51) Int. Cl. H04B 5/02; H04B 5/00; H02J 50/12; H02J 50/20

(52) U.S. Cl. CPC H04B 5/02; H02J 50/20; H02J 50/12; H04B 5/0037

(57) ABSTRACT

[Object] To provide a technology of a transmission apparatus and the like with which a resonance frequency of an antenna resonance unit can be controlled appropriately irrespective of a presence/absence of a booster, to obtain stable communication characteristics.

[Solving Means] An antenna resonance unit (110) includes an antenna coil (L1) and an impedance matching unit (114). A drive unit (e.g., antenna drive unit 130) generates a transmission signal with respect to the antenna resonance unit (110). A detection unit (106) detects a drive current or drive power for operating the drive unit. A control unit (140) is capable of generating a control signal for controlling the impedance matching unit (114), and controls a resonance frequency of the antenna resonance unit (110) using, out of the control signal, an optimal control value with which the drive current or drive power detected by the detection unit (106) becomes minimum.

### TECHNICAL FIELD

The present invention relates to a technology of a transmission apparatus and the like, for performing non-contact communication or non-contact power supply by electromagnetic coupling.

### BACKGROUND ART

In recent years, prevalence of non-contact communication systems that use NFC (Near Field Communication), which is a near field non-contact communication technology, is prominent. NFC is widely used in credit cards, electronic money, electronic tickets, ID cards, cargo management tags, memory cards, non-contact power transmission systems, and the like. In such a non-contact communication system, a transmission signal output from a transmission antenna (resonance circuit) of a reader/writer (hereinafter, referred to as R/W) apparatus dedicated to the system is received by a reception antenna provided inside a non-contact IC (Integrated Circuit) card by electromagnetic induction.

In such a non-contact communication system, in order to obtain stable communication characteristics, it is important for a frequency of a signal source in the R/W apparatus, a resonance frequency of a transmission antenna of the R/W apparatus, and a resonance frequency of the reception antenna (resonance circuit) in the non-contact IC card to match with one another. However, the resonance frequency of the reception antenna of the non-contact IC card or the transmission antenna of the R/W apparatus fluctuates due to various factors such as an environment where the R/W apparatus is used. In this case, it becomes difficult to stably transmit and receive information between the non-contact IC card and the R/W apparatus.

In this regard, in the technical field of the non-contact communication system, various technologies for maintaining a stable communication state under various conditions are proposed. For example, in a non-contact communication device disclosed Patent Literature 1, a measurement part constituted of differential amplifiers measures an output current (drive current by LSI) from an oscillation unit, in an antenna drive unit (e.g., LSI). Then, a control unit detects a minimum value or maximum value of the output current and controls a resonance frequency using an optimal control value corresponding to the minimum value or maximum value (see [Abstract] of Patent Literature 1)).

Incidentally, for example, in a non-contact type communication apparatus, a communication error may occur due to insufficient power. In this regard, a booster may be provided for amplifying communication power.

For example, Patent Literature 2 describes a necessity of using a booster. A communication distance between a non-contact RFID R/W and an RFID tag is several cm.

However, as described above, in an RFID system for various purposes, various uses are conceivable, and it is desirable that the communication distance can be further extended depending on an application field. In order to cope with this, there is proposed a technology of arranging a booster antenna between the RFID tag and the RFID R/W (described in paragraph [0005] in specification of Patent Literature 2).

Patent Literature 3 discloses a technology of providing a booster for securing a communication distance even with a small antenna. Further, in this Patent Literature 3, a detection circuit connected to an NFC controller generates a detection signal on the basis of an input signal from the NFC controller, and a power source activated by the detection signal supplies power to the booster. Accordingly, since the booster does not operate in a non-communication state, power consumption of a radio communication device can be suppressed (described in paragraphs [0005], [0016], [0019], and [0025] in specification of Patent Literature 3).

### CITATION LIST

### Patent Literature

Patent Literature 1: Japanese Patent Application Laid-open No. 2016-25460

Patent Literature 2: Japanese Patent Application Laid-open No. 2009-21970

Patent Literature 3: Japanese Patent Application Laid-open No. 2015-177389

### DISCLOSURE OF INVENTION

### Technical Problem

It is difficult to install a booster antenna coil inside a compact transmitter such as a memory card. Further, regardless of a presence/absence of the booster, a resonance frequency is required to be controlled to an appropriate resonance frequency in various environments.

An object of the present invention is to provide a technology of a transmission apparatus and the like, with which a resonance frequency of an antenna can be appropriately controlled irrespective of a presence/absence of a booster, to thus obtain stable communication characteristics.

### Solution to Problem

To attain the object described above, a transmission apparatus according to an embodiment of the present invention includes an antenna resonance unit, a drive unit, a detection unit, and a control unit.

The antenna resonance unit includes an antenna coil and an impedance matching unit.

The drive unit generates a transmission signal with respect to the antenna resonance unit.

The detection unit detects a drive current or drive power for operating the drive unit.

The control unit is capable of generating a control signal for controlling the impedance matching unit, and controls a resonance frequency of the antenna resonance unit using, out of the control signal, an optimal control value with which the drive current or drive power detected by the detection unit becomes minimum.

With such a configuration, since the resonance frequency is controlled such that the drive current for operating the drive unit or the drive power based on the drive current becomes minimum, it becomes possible to appropriately control the resonance frequency of the antenna in accordance with a fluctuation of an environment where the transmission apparatus is used irrespective of a presence/absence of the booster, to thus obtain stable communication characteristics.

The control unit may detect the optimal control value by outputting the control signal within a predetermined search range.

The detection unit may output a mean value or effective value of the drive current.

The transmission apparatus may further include a storage unit that stores an optimal time difference between the transmission signal and an antenna current flowing through the antenna coil, the optimal time difference being an optimal time difference corresponding to a controlled amount of the impedance matching unit at a time the drive current or drive power becomes minimum.

Accordingly, the control unit can control, on the basis of the optimal time difference, the resonance frequency using the optimal control value corresponding to that optimal time difference.

The transmission apparatus may further include a measurement unit that measures a time difference between the transmission signal and the antenna current flowing through the antenna coil.

The control unit may acquire the time difference measured by the measurement unit by outputting the control signal within a predetermined search range, and detect the optimal control value on a basis of a result of a comparison between the measured time difference and the optimal time difference.

Accordingly, the transmission apparatus can use the optimal control value corresponding to the environment fluctuation.

The measurement unit may include a phase comparator that compares a phase of the transmission signal that is output from the drive unit and input to the antenna resonance unit and a phase of the antenna current.

The drive unit may include an oscillation unit, and a pair of differential amplifiers to which a signal from the oscillation unit is input, the pair of differential amplifiers respectively generating, as the transmission signal, a first signal and a second signal having a phase opposite to that of the first signal.

The phase comparator may be configured to compare a phase of the first signal and the phase of the antenna current by the first signal, out of the signals respectively generated by the pair of differential amplifiers.

The drive unit may include an external drive unit that amplifies the antenna current, an oscillation unit, and a pair of differential amplifiers to which a signal from the oscillation unit is input, the pair of differential amplifiers respectively generating, as the transmission signal, a first signal and a second signal having a phase opposite to that of the first signal.

The phase comparator may be configured to compare a phase of the first signal and the phase of the antenna current by the second signal, out of the signals respectively generated by the pair of differential amplifiers.

The drive unit may include an external drive unit that amplifies the antenna current.

A transmission apparatus according to an embodiment of the present invention includes an antenna resonance unit, a drive unit, a measurement unit, and a control unit.

The antenna resonance unit includes an antenna coil and an impedance matching unit.

The drive unit generates a transmission signal with respect to the antenna resonance unit.

The measurement unit measures time differences between the transmission signal and an antenna current flowing through the antenna coil.

The control unit is capable of generating a control signal for controlling the impedance matching unit, and controls a resonance frequency of the antenna resonance unit using, out of the control signal, an optimal control value corresponding to an optimal time difference at a time a drive current or drive power for operating the drive unit becomes minimum, out of the time differences measured by the measurement unit.

With such a configuration, since the optimal time difference is used to control the resonance frequency such that the drive current for operating the drive unit or the drive power based on the drive current becomes minimum, it becomes possible to appropriately control the resonance frequency of the antenna irrespective of the presence/absence of the booster, to thus obtain stable communication characteristics.

An antenna drive apparatus according to an embodiment of the present invention is an antenna drive apparatus that drives an antenna resonance unit including an antenna coil and an impedance matching unit, the antenna drive apparatus including a generation unit, an acquisition unit, and a control unit.

The generation unit generates a transmission signal with respect to the antenna resonance unit.

The acquisition unit acquires a value of a drive current detected by a detection unit that detects a drive current or drive power for operating the drive unit.

The control unit is capable of generating a control signal for controlling the impedance matching unit, and controls a resonance frequency of the antenna resonance unit using, out of the control signal, an optimal control value with which the drive current or drive power detected by the detection unit becomes minimum.

An antenna drive apparatus according to an embodiment of the present invention is an antenna drive apparatus that drives an antenna resonance unit including an antenna coil and an impedance matching unit, the antenna drive apparatus including a generation unit, an acquisition unit, and a control unit.

The generation unit generates a transmission signal with respect to the antenna resonance unit.

The acquisition unit acquires a time difference measured by a measurement unit that measures time differences between the transmission signal and an antenna current flowing through the antenna coil.

The control unit is capable of generating a control signal for controlling the impedance matching unit, and controls a resonance frequency of the antenna resonance unit using, out of the control signal, an optimal control value corresponding to an optimal time difference at a time a drive current or drive power for operating the drive unit becomes minimum, out of the time differences measured by the measurement unit.

A tuning method according to an embodiment of the present invention is a tuning method executed by a transmission apparatus including the antenna resonance unit described above and the drive unit described above, the tuning method being a method of tuning a resonance frequency of the antenna resonance unit.

A control signal for controlling the impedance matching unit is output.

By detecting a drive current or drive power for operating the drive unit in accordance with the output of the control signal, an optimal control value with which the drive current or drive power becomes minimum is detected out of the control signal.

A tuning method according to another embodiment of the present invention is a tuning method executed by a transmission apparatus including the antenna resonance unit described above and the drive unit described above, the tuning method being a method of tuning a resonance frequency of the antenna resonance unit.

A control signal for controlling the impedance matching unit is output.

Time differences between the transmission signal and an antenna current flowing through the antenna coil are measured in accordance with the output of the control signal.

A comparison is made between the measured time difference and an optimal time difference between the transmission signal and an antenna current flowing through the antenna coil, the optimal time difference being an optimal time difference corresponding to a controlled amount of the impedance matching unit at a time a drive current or drive power for operating the drive unit becomes minimum, to detect, out of the control signal, an optimal control value with which the drive current or drive power becomes minimum.

A program of the transmission apparatus for executing the tuning method may also be provided.

### Advantageous Effects of Invention

As described above, according to the present invention, the resonance frequency of the antenna can be appropriately controlled irrespective of the presence/absence of the booster, to obtain stable communication characteristics.

### BRIEF DESCRIPTION OF DRAWINGS

FIG. 1 is a block diagram showing a configuration of a non-contact communication system according to an embodiment of the present invention.

FIG. 2 shows a circuit configuration of a transmission apparatus not including a booster, as a transmission apparatus shown in FIG. 1.

FIG. 3 shows a circuit configuration of a transmission apparatus including a booster, as the transmission apparatus shown in FIG. 1.

FIG. 4 shows a basic circuit configuration of a transmission apparatus not including a booster according to a reference example.

FIG. 5 shows a basic circuit configuration of a transmission apparatus including a booster according to a reference example.

FIGS. 6A to 6C are graphs showing calculation results of signals of respective units under a resonance condition in the transmission apparatus according to the reference example shown in FIG. 4.

FIGS. 7A to 7C are graphs showing signals of the respective units under the resonance condition in the transmission apparatus according to the reference example shown in FIG. 5.

FIG. 8 is a table summarizing the resonance conditions for both the transmission apparatuses with and without a booster.

FIG. 9A is a graph showing a relationship among a capacity Cp, drive power, an antenna current, and a time difference for the transmission apparatus not including a booster.

FIG. 9B is a graph showing a relationship among the capacity Cp, the drive power, the antenna current, and the time difference for the transmission apparatus including a booster.

FIG. 10 is a graph showing a relationship among the capacity Cp, the antenna current, and drive power for matching impedances of various values in the transmission apparatus including a booster.

FIG. 11 is a graph showing a relationship between the capacity Cp and time difference for the matching impedances of various values in the transmission apparatus including a booster.

FIG. 12 is a graph showing a relationship among the matching impedance, the antenna current, the time difference, and the drive power in the transmission apparatus including a booster.

FIG. 13 is a flowchart showing a tuning method by a minimum drive power method.

FIG. 14 is a flowchart showing a tuning method by an optimal time difference method.

FIG. 15 is a block diagram showing a configuration of a non-contact power feeding system.

FIG. 16 shows a circuit configuration of a transmission apparatus (power feeding apparatus) including an external drive circuit in the non-contact power feeding system.

FIG. 17 shows a configuration of the external drive circuit.

### MODES FOR CARRYING OUT THE INVENTION

Hereinafter, embodiments of the present invention will be described with reference to the drawings.

### 1. Non-Contact Communication System

### 1.1) Configuration of Non-Contact Communication System

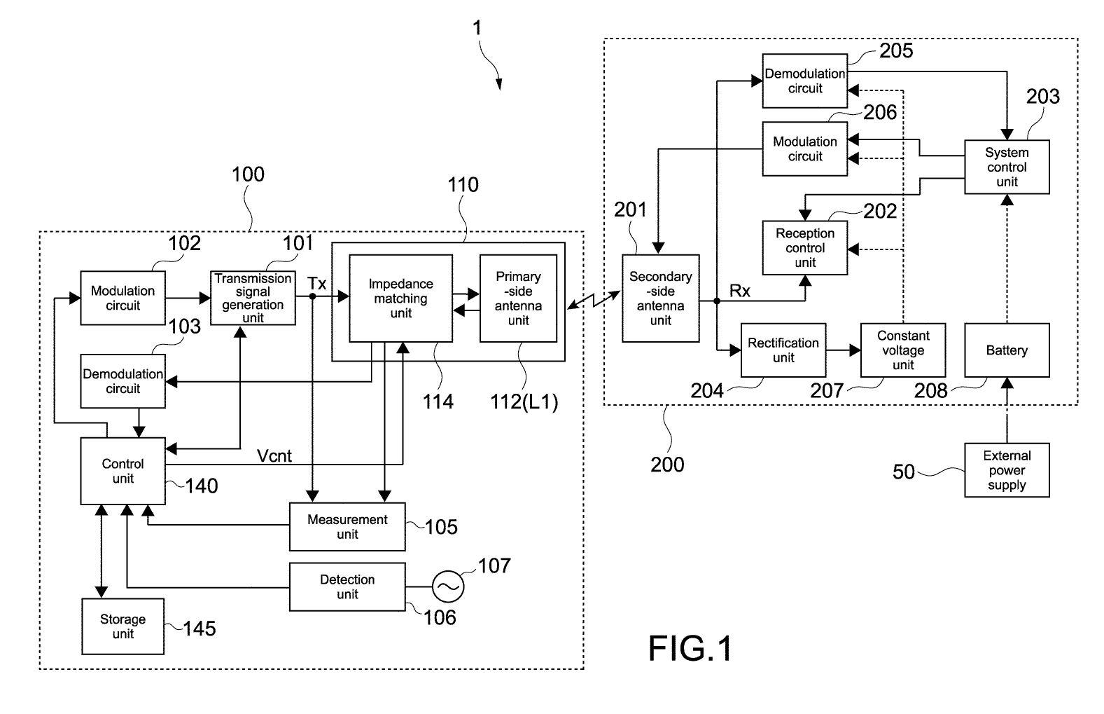

FIG. 1 is a block diagram showing a configuration of a non-contact communication system according to an embodiment of the present invention. It should be noted that in FIG. 1, wirings related to an input/output of information among respective circuit blocks are indicated by arrows in solid lines, and wirings related to electric power supply are indicated by arrows in broken lines.

A non-contact communication system 1 according to the embodiment of the present invention is applied to NFC (Near Field Communication) which is a near field communication technology including NFC-A, NFC-B, NFC-F, and the like conforming to an international standard ISO/IEC 18092.

The non-contact communication system 1 includes a transmission apparatus 100 and a reception apparatus 200. The non-contact communication system 1 exchanges information with the transmission apparatus 100 and the reception apparatus 200 by non-contact communication. It should be noted that an example of the non-contact communication system 1 is a communication system obtained by combining a non-contact IC card standard typified by Felica (registered trademark) and an NFC standard.

### 1.2) Transmission Apparatus

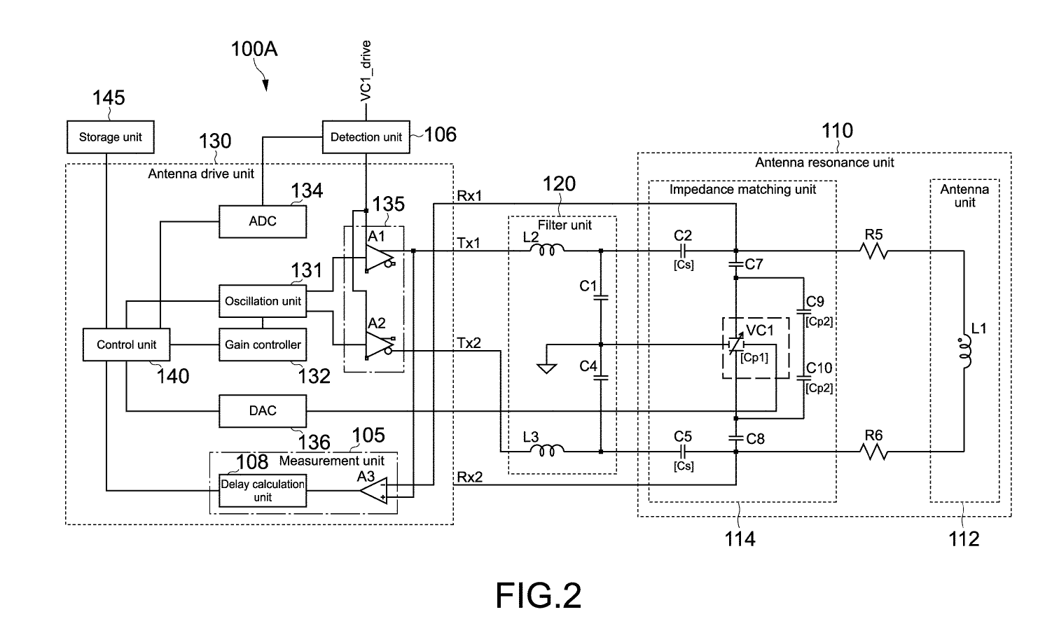

The transmission apparatus 100 will be described. The transmission apparatus 100 is an apparatus including a reader/writer (R/W) function for reading/writing data to/from the reception apparatus 200 in a non-contact manner. As shown in FIG. 1, the transmission apparatus 100 includes an antenna resonance unit 110, an antenna drive unit 130 (drive unit, antenna drive apparatus) (see FIG. 2), a detection unit 106, and a storage unit 145.

As shown in FIG. 1, the antenna resonance unit 110 includes a primary-side antenna unit 112 and an impedance matching unit 114, and configures a resonance circuit including an antenna coil L1 and a resonance capacitor (variable capacitance capacitor) as will be described later. The antenna resonance unit 110 exchanges signals with a secondary-side antenna unit 201 of the reception apparatus 200 by electromagnetic coupling.

The primary-side antenna unit 112 includes a function of transmitting a transmission signal of a desired frequency by the resonance circuit and receiving a response signal from the reception apparatus 200.

The impedance matching unit 114 includes a function as a matching circuit that causes impedances between a transmission signal generation unit (generation unit) 101 of the antenna drive unit 130 and the primary-side antenna unit 112 to match. In this embodiment, as will be described later, a control unit of the antenna drive unit 130 controls the impedance matching unit 114 as will be described later, to realize impedance matching with respect to the transmission signal generation unit 101 and the primary-side antenna unit 112 and optimization of a resonance frequency.

The antenna drive unit 130 mainly includes the transmission signal generation unit 101, a modulation circuit 102, a demodulation circuit 103, and a control unit 140.

The transmission signal generation unit 101 includes a function of modulating carrier signals of a desired frequency (e.g., 13.56 MHz) by transmission data input from the modulation circuit 102 and outputting the modulated carrier signals to the primary-side antenna unit 112 via the impedance matching unit 114.

The modulation circuit 102 includes a function of encoding transmission data input from the control unit 140 and outputting the encoded transmission data to the transmission signal generation unit 101.

The demodulation circuit 103 includes a function of acquiring a response signal received by the primary-side antenna unit 112 via the impedance matching unit 114 and demodulating the response signal. The demodulation circuit 103 also includes a function of outputting demodulated response data to the control unit 140.

The control unit 140 includes a function of generating various control command signals in accordance with commands from outside or a built-in program, and outputting the command signals to the modulation circuit 102 to control an operation of the circuit. Further, the control unit 140 includes a function of generating transmission data corresponding to the command signal and supplying the transmission data to the modulation circuit 102. Further, the control unit 140 includes a function of carrying out predetermined processing on the basis of response data demodulated by the demodulation circuit 103.

Specifically, the control unit 140 includes a function of controlling an R/W function and card function of the transmission apparatus 100. The R/W function is a function of the transmission apparatus 100 for communicating (reading and writing data) with the reception apparatus 200 as a secondary-side apparatus (counterpart apparatus). The card function is a function of the reception apparatus 200 as the secondary-side apparatus shown in FIG. 1, and means that the transmission apparatus 100 includes that function.

Further, the control unit 140 generates a control signal (e.g., control voltage) for controlling the impedance matching unit 114, and outputs the control signal to the impedance matching unit 114. As will be described later, the impedance matching unit 114 includes a variable capacitor (variable capacitance capacitor), and a capacity of the variable capacitor (controlled amount) is controlled by the control signal. Accordingly, the resonance frequency of the antenna resonance unit 110 is controlled.

It should be noted that the control unit 140 may be functionally or physically separated into a control unit that controls an entire system of the transmission apparatus 100 and a transmission/reception control unit that controls transmission/reception of signals. In this case, the transmission/reception control unit is configured to mainly execute control of the impedance matching unit 114.

The control unit 140 is mainly constituted of, for example, a CPU (Central Processing Unit) and/or a PLD (Programmable Logic Device).

The detection unit 106 includes a function of detecting a current supplied from a power supply 107 connected to the antenna drive unit 130. This current is a drive current for the antenna driver 130 (and/or booster to be described later) to operate.

### 1.3) Reception Apparatus

Next, the reception apparatus 200 will be described. It should be noted that in the example shown in FIG. 1, an example in which the reception apparatus 200 is configured as a mobile apparatus that operates as a non-contact IC card is shown. Further, in this example, an example in which the reception apparatus 200 includes a function of controlling its own resonance frequency will be described.

As shown in FIG. 1, the reception apparatus 200 includes the secondary-side antenna unit 201 including a function as a reception antenna, a rectification unit 204, a reception control unit 202, a demodulation circuit 205, a system control unit 203, a modulation circuit 206, a constant voltage unit 207, and a battery 208.

The secondary-side antenna unit 201 includes a resonance circuit constituted of, for example, a resonance coil and a plurality of resonance capacitors (not shown). This resonance capacitor includes a variable capacitor whose capacitance varies by applying a control voltage. The secondary-side antenna unit 201 includes a function of communicating with the primary-side antenna unit 112 of the transmission apparatus 100 by electromagnetic coupling and receiving the transmission signal from the transmission apparatus 100 by a magnetic field generated by the primary-side antenna unit 112. At this time, the capacitance of the variable capacitor is controlled so that the resonance frequency of the secondary-side antenna unit 201 becomes a desired frequency.

For example, the rectification unit 204 is constituted of a half-wave rectification circuit including a rectification diode and a rectification capacitor, and includes a function of rectifying AC power received by the secondary-side antenna unit 201 into DC power and outputting the rectified DC power to the constant voltage unit 207.

The constant voltage unit 207 includes a function of carrying out voltage fluctuation (data component) suppression processing and stabilization processing on electric signals (DC power) input from the rectification unit 204 and supplying the processed DC power to the reception control unit 202. It should be noted that the DC power output via the rectification unit 204 and the constant voltage unit 207 is used as a power supply for operating an IC in the reception apparatus 200.

The reception control unit 202 includes a function of controlling resonance characteristics of the secondary-side antenna unit 201 and optimizing the resonance frequency at the time of reception. Specifically, a control voltage is applied to the variable capacitor included in the secondary-side antenna unit 201 to control the capacitance thereof. Accordingly, the resonance frequency of the secondary-side antenna unit 201 is controlled.

The demodulation circuit 205 includes a function of demodulating the reception signal received by the secondary-side antenna unit 201 and outputting the demodulated signal to the system control unit 203.

The system control unit 203 includes a function of carrying out, on the basis of the signal demodulated by the demodulation circuit 205, processing requisite for determining a content thereof, to control the modulation circuit 206 and the reception control unit 202.

The modulation circuit 206 includes a function of modulating a reception carrier in accordance with a result (content of demodulation signal) determined by the system control unit 203 and generating a response signal. Further, the modulation circuit 206 includes a function of outputting the generated response signal to the secondary-side antenna unit 201. The response signal output from the modulation circuit 206 is transmitted from the secondary-side antenna unit 201 to the primary-side antenna unit 112 by non-contact communication.

The battery 208 includes a function of supplying power to the system control unit 203. Charging of the battery 208 is performed by connecting a charge terminal thereof to an external power supply 50. As in the example shown in FIG. 1, in a case where the battery 208 is incorporated into the reception apparatus 200, more stable electric power can be supplied to the system control unit 203, and thus a stable operation becomes possible.

It should be noted that the reception apparatus 200 may be configured to drive the system control unit 203 using the DC power generated via the rectification unit 204 and the constant voltage unit 207 without using the battery 208.

In the non-contact communication system 1 of this embodiment, non-contact data communication is performed between the primary-side antenna unit 112 of the transmission apparatus 100 and the secondary-side antenna unit 201 of the reception apparatus 200 via electromagnetic coupling. Therefore, for the transmission apparatus 100 and the reception apparatus 200 to communicate efficiently, the resonance circuits of the primary-side antenna unit 112 and the secondary-side antenna unit 201 are configured to resonate at the same carrier frequency (e.g., 13.56 MHz).

### 2. Circuit Configuration of Transmission Apparatus

### 2.1) Transmission Apparatus not Including Booster (External Drive Unit)

FIG. 2 shows a circuit configuration of a transmission apparatus 100A not including a booster, as the transmission apparatus 100 shown in FIG. 1. In the transmission apparatus 100A including no booster, the antenna drive unit 130 functions as a “drive unit”.

The antenna resonance unit 110 includes the antenna coil L1 and the impedance matching unit 114 connected to the antenna coil L1. The impedance matching unit 114 prevents an impedance mismatch between the antenna drive unit 130 and the antenna coil L1 and always keeps a load (impedance) of the antenna drive unit 130 constant and purely resistive regardless of the antenna coil L1.

For example, the antenna resonance unit 110 is configured as a series-parallel resonance circuit in which a variable capacitor (parallel resonance capacitor) VC1 is connected in parallel to the antenna coil L1 and capacitors C2 and C5 (series resonance capacitors) of fixed capacitances are connected in series. As a control voltage (control signal) input to the variable capacitor VC1 changes, the capacitance of the variable capacitor VC1 changes, thereby changing the resonance frequency of the antenna resonance unit 110. It should be noted that it is also possible to provide a plurality of variable capacitors and configure them such that the capacitances of the plurality of variable capacitors change by the same control voltage value. Capacitors C9 and C10 (parallel resonance capacitors) are additional capacitors for absorbing an antenna characteristic difference due to a difference in an antenna size and the like. When the capacitances of the capacitors C9 and C10 are represented by Cp2 and the capacitance of the variable capacitor VC1 is represented by Cp1, a combined capacitance of these becomes Cp1+Cp2/2. The variable capacitance capacitor VC1 is configured such that the capacitance decreases as the applied control voltage increases. Therefore, the resonance frequency increases as the control voltage increases.

The capacitors C7 and C8 include a DC cut function for preventing the control voltage (DC voltage) applied to the variable capacitor VC1 from leaking to na antenna L3. The capacitances of the capacitors C7 and C8 are set to 10 nF which is sufficiently larger than, for example, 200 pF as the combined capacitance (Cp1+Cp2/2), in order to reduce an influence during execution of tuning to be described later. In a case where the capacitances of the capacitors C7 and C8 are small, there is an influence that a variable rate of the variable capacitor VC1 decreases, and the like.

The impedance matching unit 114 includes damping resistors R5 and R6 that determine a Q value (Quality factor, sharpness) of the antenna resonance unit 110. In this embodiment, these become short resistors (0Ω).

A filter unit 120 includes coils L2 and L3 and capacitors C1 and C4 and includes an EMC (Electro Magnetic Compatibility) function. A high-frequency oscillation signal (transmission signal described above) output from the antenna drive unit 130 is a rectangular wave. The filter unit 120 includes a function of removing high-frequency noises due to this oscillation signal. A cutoff frequency thereof is 16 MHz to 20 MHz. The coils L2 and L3 are respectively connected to one of the terminals of the capacitors C2 and C5. The capacitors C1 and C4 are respectively connected between the coils L2 and L3 and the ground.

The transmission signal generation unit 101 of the antenna drive unit 130 includes an oscillation unit 131 capable of controlling an oscillation frequency, a pulse generation unit 135 that supplies an oscillation signal obtained by the oscillation unit 131 to the antenna resonance unit 110, and a gain controller 132 that controls an output gain of the oscillation unit 131. The pulse generation unit 135 also functions as the drive unit.

The oscillation unit 131 is constituted of a frequency variable oscillator that is controlled by the control unit 140 to output a signal of a transmission frequency over a wide range of 12 MHz to 17 MHz. Typically, the oscillation frequency is controlled to 13.56 MHz, but in terms of design, the oscillation frequency may be controlled to an oscillation frequency offset from 13.56 MHz. That offset oscillation frequency is a unique value that differs depending on a manufacturer or a product model.

The control unit 140 performs control so that the oscillation frequency output by the oscillation unit 131 matches a target frequency f0 (13.56 MHz described above or oscillation frequency offset from 13.56 MHz).

In this embodiment, the target frequency f0 is a design value determined by design, such as an inductance, Q value, and impedance of the antenna resonance unit 110. These are design values that determine the antenna characteristics.

The pulse generation unit 135 generates a positive-phase pulse signal (e.g., first signal) and a pulse signal having a phase opposite to that of the positive-phase pulse signal (e.g., second signal) from the high-frequency oscillation signal supplied from the oscillation unit 131, and outputs these signals to the filter unit 120 as transmission signals. For example, the pulse generation unit 135 includes a pair of differential amplifiers A1 and A2 that respectively generate these two signals.

The antenna drive unit 130 includes a DAC (digital/analog converter) 136 that converts a digital control voltage value from the control unit 140 into an analog signal. The analog bias control voltage converted by the DAC 136 is applied to the variable capacitor VC1. Further, the antenna drive unit 130 includes an ADC (analog/digital converter) 134 that digitizes a DC voltage signal indicating a current value detected by the detection unit 106.

The antenna drive unit 130 includes a measurement unit 105 that measures a time difference between a transmission signal of the pulse generation unit 135 and an antenna current as a current flowing through the antenna unit. For example, the measurement unit 105 includes a phase comparator A3 and a delay calculation unit 108. An antenna current flows through the antenna coil L1 according to transmission signals constituted of signals respectively output from a Tx1 terminal and a Tx2 terminal. The phase of the antenna current can be taken into the antenna drive unit 130 using Rx1 terminals (or Rx2 terminals in transmission apparatus 100B to be described later) connected to both ends of the antenna coil L1.

For example, a signal from the differential amplifier A1 is input, as the transmission signal, to a non-inverting input terminal of the phase comparator A3. A signal of an antenna current by the transmission signal (current flowing through line to which transmission signal is supplied in impedance matching unit 114) is input to an inverting input terminal. The phase comparator A3 is configured to compare the phases of these signals and output a voltage signal corresponding to the phase difference. The delay calculation unit 108 includes a function of calculating the time difference on the basis of that phase difference and outputting it to the control unit 140.

The measurement unit 105 may be provided outside the antenna drive unit 130.

The transmission apparatus 100A includes the storage unit 145 that stores antenna parameters, setting values such as an oscillation frequency of the oscillation unit 131, the time difference, and the like.

The antenna drive unit 130 is constituted of, for example, LSI (Large Scale Integration). At least one of the detection unit 106 and the storage unit 145 may be provided inside this LSI. In addition, a part or all of the circuits constituting the control unit 140 may be provided outside this LSI (antenna drive unit 130).

In an RW mode for realizing the R/W function, the control unit 140 executes control such that the oscillation unit 131 oscillates at an arbitrary frequency within the frequency range described above and the pulse generation unit 135 outputs signals having that frequency to the Tx1 terminal and the Tx2 terminal, respectively. On the other hand, in a card mode for realizing the card function, the control unit 140 executes control to detect a reception signal induced to the antenna coil L1 of the antenna resonance unit 110 by a reception circuit (not shown) and respond by a load modulation.

### 2.2) Transmission Apparatus Including Booster (External Drive Unit)

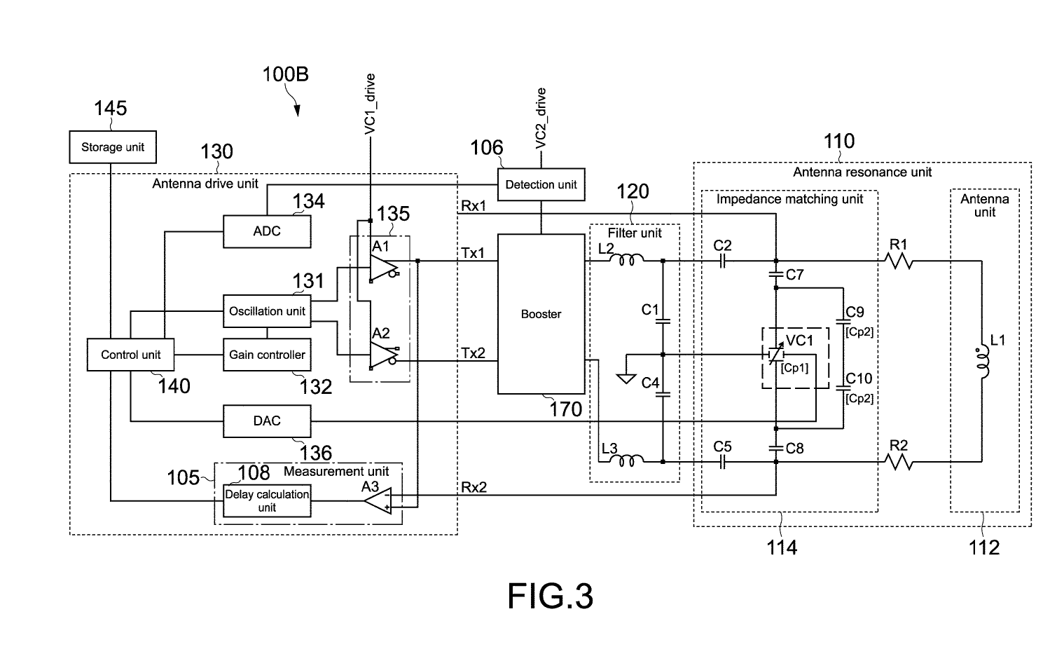

FIG. 3 shows a circuit configuration of a transmission apparatus 100B including a booster, as the transmission apparatus 100 shown in FIG. 1. In descriptions hereinafter, elements, functions, and the like that are substantially similar to those of the transmission apparatus according to the embodiment shown in FIG. 2 are denoted by the same reference numerals, descriptions thereof will be simplified or omitted, and different points will mainly be described.

This transmission apparatus 100B includes a booster 170 connected between the antenna drive unit 130 and the filter unit 120. In the transmission apparatus 100B including the booster, the booster 170 mainly functions as the “drive unit”. The booster 170 includes a function of increasing an amplitude of the antenna current by amplifying an output voltage from the antenna drive unit 130.

A power supply line (line of VC2_drive) different from a power supply line to the pulse generation unit 135 (line of VC1_drive) in the transmission apparatus 100A shown in FIG. 2 is connected to the booster 170 via the detection unit 106. In other words, the detection unit 106 detects electric power (current) supplied to the booster 170.

In the transmission apparatus 100A shown in FIG. 2, an antenna current signal Rx1 based on the signal generated by the differential amplifier A1 is input to the inverting input terminal of the phase comparator A3 in the measurement unit 105 as described above. In contrast, in the transmission apparatus 100B, an antenna current (current flowing through line to which signal generated by differential amplifier A2 is supplied in impedance matching unit 114) signal Rx2 based on a signal generated by the differential amplifier A2 in the pulse generation unit 135 is input to the inverting input terminal of the phase comparator A3. The meaning of this difference will be described later.

### 3. Reference Examples to Help Understand Operation of Transmission Apparatus (FIGS. 1 and 2) According to this Embodiment

### 3.1) Configuration of Signal Apparatus According to Reference Example

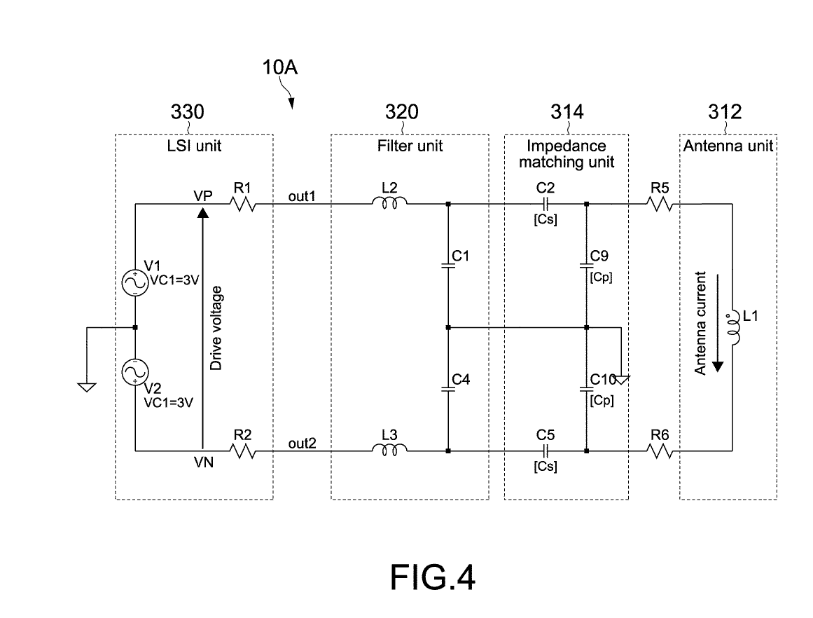

FIG. 4 shows a basic circuit configuration of a transmission apparatus not including a booster according to a reference example. This transmission apparatus 10A includes an LSI unit 330 (antenna drive unit), a filter unit 320, an impedance matching unit 314, and an antenna coil L1. The impedance matching unit 314 includes series resonance capacitors C2 and C5 and parallel resonance capacitors C9 and C10 of fixed capacitances.

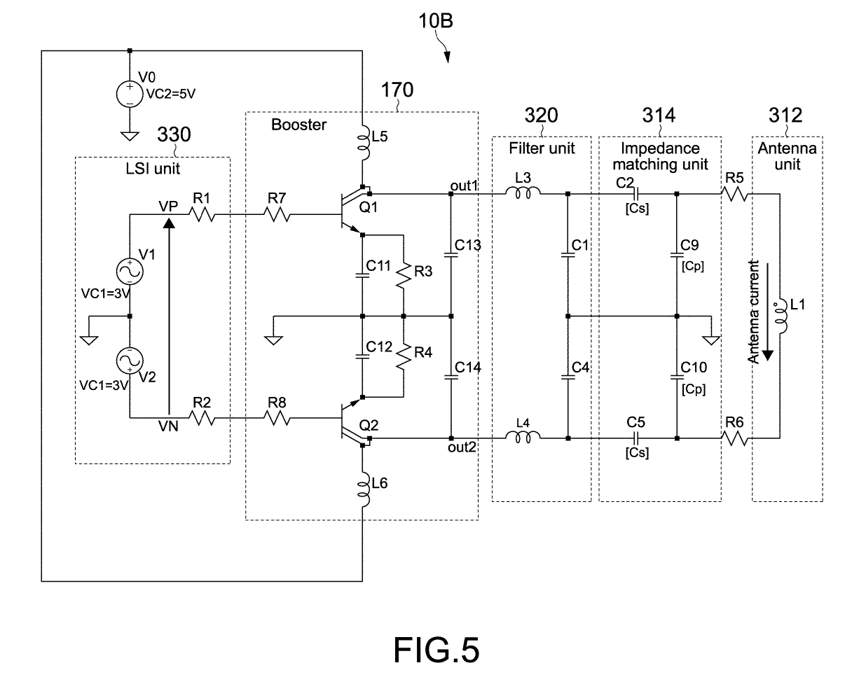

FIG. 5 shows a basic circuit configuration of a transmission apparatus including the booster 170 according to a reference example. In this transmission apparatus 10B, the booster 170 is inserted between the LSI unit 330 and the filter unit 320 in the transmission apparatus 10A shown in FIG. 4. This booster 170 is, for example, a circuit used in a settlement terminal.

The booster 170 performs a voltage amplification by transistors Q1 and Q2 and coils L5 and L6. The drive voltage is, for example, 5 V. By the transistors Q1 and Q2 turning on/off the respective currents flowing through the coils L5 and L6, a voltage higher than the drive voltage of 5 V is generated, to thus increase the drive current.

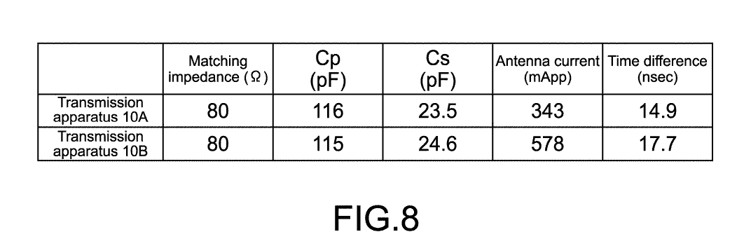

Capacitances of capacitors C13 and C14 are set to satisfy ωL=1/ωC in order to correct a phase delay by the coils L5 and L6 and to make a phase change by the booster 170 almost zero. Since the phase change in the booster 170 is canceled out by the coil L5 and the capacitor C1, the same value can be used for the capacitances of the capacitors C2, C5, C9, and C10 of the impedance matching unit 314 regardless of the presence/absence of the booster 170. In actuality, an influence of an output impedance of the LSI unit 330 and a phase correction deviation by the capacitor C13 are caused. Therefore, as shown in the table of FIG. 8, the capacitances of the parallel resonance capacitors C9 and C10 and the series resonance capacitors C2 and C5 are optimized.

The booster 170 in the transmission apparatus 100B shown in FIG. 3 includes a configuration similar to that of the booster 170 shown in FIG. 5.

### 3.2) Time Difference Between Drive Pulse and Antenna Current

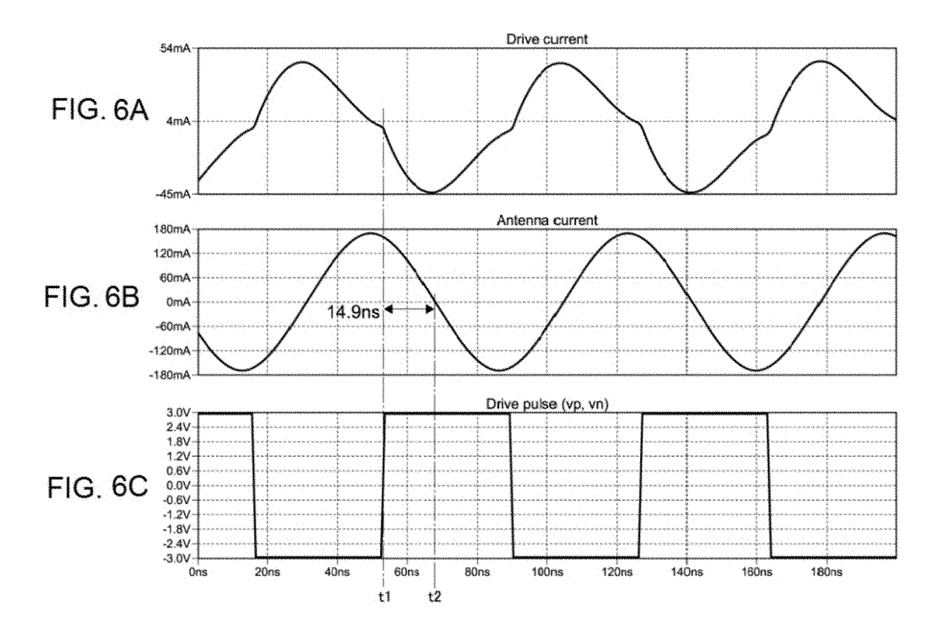

FIGS. 6A to 6C are graphs showing calculation results of signals of the respective units under a resonance condition (state where capacitors C2, C5, C9, and C10 are optimized) in the transmission apparatus 10A according to the reference example shown in FIG. 4. Specifically, FIG. 6A shows a current flowing through the resistor R1 in the LSI unit 330, the current being a drive current for operating the LSI unit 330. FIG. 6B shows the antenna current flowing through the antenna coil L1. FIG. 6C shows drive pulses by power supplies V1 and V2.

It should be noted that electric power corresponding to electric power supplied by the power supply 107 shown in FIG. 1 corresponds to a part of the electric power supplied from the power supplies V1 and V2 shown in FIG. 4 (“VC1_drive” in FIG. 2).

Obtaining a time difference between the drive pulse (i.e., transmission signal) and the antenna current under such a resonance condition will be considered. For that purpose, it is necessary to consider a phase reference point of each of the drive pulse and the antenna current.

In this transmission apparatus 10A, the drive pulse is generated by a differential circuit that is driven by two pulses in which phases of the voltages V1 and V2 are shifted by 180° (polarity inverted). Since the drive pulse is a difference signal of VP and VN, it becomes 6 Vpp of −3 to +3V. The phase reference point of the drive pulse is a point at which 0 V is obtained, which is a drive pulse rise timing t1.

Since the transmission apparatus 10A drives the circuit including the coil, the drive current is not sinusoidal but is distorted. The phase reference point of the drive current is a point at which 0 mA is obtained. In contrast, because of the resonance circuit of 13.56 MHz, the antenna current draws a beautiful sinusoidal wave, and 0 mA of the phase reference point of the antenna current can be easily obtained.

Under such a resonance condition, the time difference between the phase reference point of the drive pulse, that is, the drive pulse rise timing t1 and the timing t2 of the phase reference point of the antenna current, was 14.9 ns. A phase difference corresponding to this time difference (t2−t1) can be calculated from the time difference 14.9 ns and the frequency 13.56 MHz.

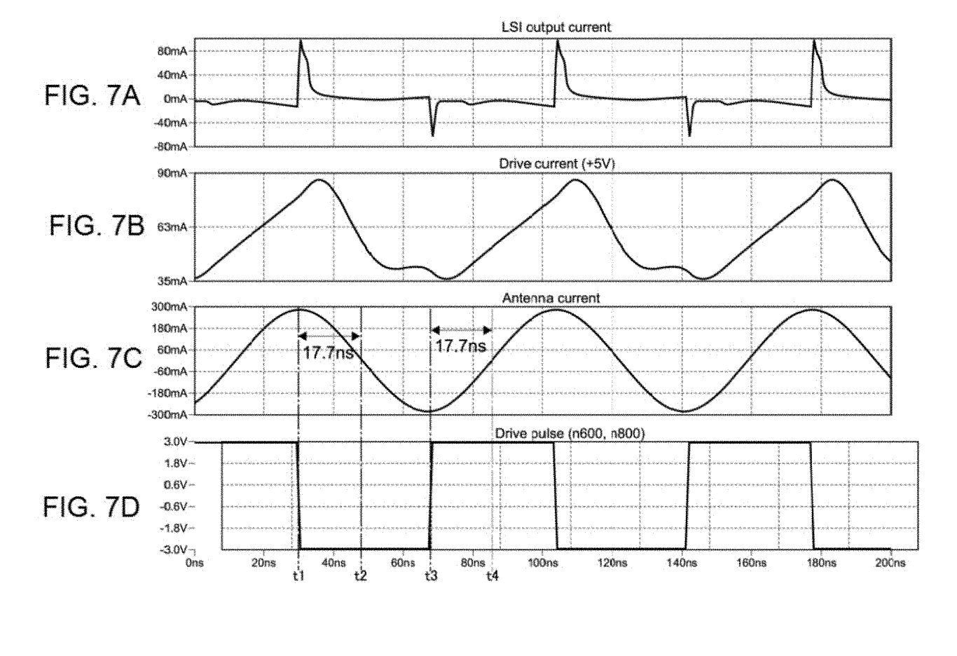

FIGS. 7A to 7C are graphs showing the signals of the respective units under the resonance condition (state where capacitors C2, C5, C9, and C10 are optimized) in the transmission apparatus 10B according to the reference example shown in FIG. 5. Specifically, FIG. 7A shows a current flowing through the resistor R1 in the LSI unit 330. FIG. 7B shows a current flowing through the coil L5 of the booster 170, that is, the drive current (e.g., power supply current with drive voltage of 5 V). FIG. 7C shows the antenna current, and FIG. 7D shows the drive pulses by the power supplies V1 and V2.

It should be noted that the electric power corresponding to the electric power supplied by the power supply 107 shown in FIG. 1 corresponds to a part of the electric power supplied from the power supply V0 shown in FIG. 4 (“VC2_drive” in FIG. 3).

Also for this transmission apparatus 10B, obtaining a time difference between the drive pulse (i.e., transmission signal) and the antenna current will be considered as in the case of the transmission apparatus 10A.

In this transmission apparatus 10B, it can be seen that a large distortion is caused in the drive current as shown in FIG. 7B and the phase reference point of that drive current is uncertain due to a boost effect by the coils L5 and L6 of the booster 170.

As shown in FIG. 7A, it can be seen that since the output current of the LSI unit 330, that corresponds to the drive current of FIG. 6A, only needs to drive the transistors Q1 and Q2, the current becomes a pulse-like drive current, the current value becomes small, and there are many distortions without being a continuous wave. Therefore, it can be seen that it is not easy (unsuited) to carry out a current detection of the output current of the LSI unit 330.

As shown in FIG. 7C, it can be seen that the amplitude of the antenna current is increased by 1.7 times as compared to the antenna current shown in FIG. 6B despite the fact that an impedance Z is the same 80Ω by the booster 170.

In the transmission apparatus 10B, the pulse signal output from the LSI unit 330 is inverted by the transistors Q1 and Q2. Therefore, the phase reference point of the antenna current needs to be shifted (inverted) from a falling edge indicated by the timing t2 in FIG. 7D to a rising edge indicated by a timing t4. In other words, the phase reference point needs to be shifted by a half cycle of the drive pulse.

In this case, the time difference between the phase reference points of the drive pulse and the antenna current is from the timing t3 of the rising edge of the drive pulse to the timing t4 of the phase reference point of the antenna current (point where current reaches 0 mA from rise). The time difference (t4−t3) is 17.7 ns.

The time difference between the drive pulse falling timing t1 and the timing t2 of the phase reference point of the antenna current (point where current reaches 0 mA from fall) is the same 17.7 ns.

This time difference (17.7 ns) in the transmission apparatus 10B takes a value that is about 3 ns larger than the time difference in the transmission apparatus 10A (14.9 ns) due to a time delay by the transistor Q1 or a phase correction deviation by the capacitor C13.

In order to realize the shift of the phase reference point or the edge inversion, as shown in FIG. 3, a signal input to the inverting input terminal of the phase comparator A3 in the transmission apparatus 10B differs from a signal input to the inverting input terminal of the phase comparator A3 in the transmission apparatus 10A (shifted or inverted 180°).

### 3.3) Resonance Condition

FIG. 8 is a table summarizing the resonance conditions of the transmission apparatuses 10A and 10B. Specifically, the matching impedance, the capacitance (Cp) of the parallel resonance capacitors C9 and C10, the capacitance (Cs) of the series resonance capacitors C2 and C5, the antenna current, and the time difference are shown.

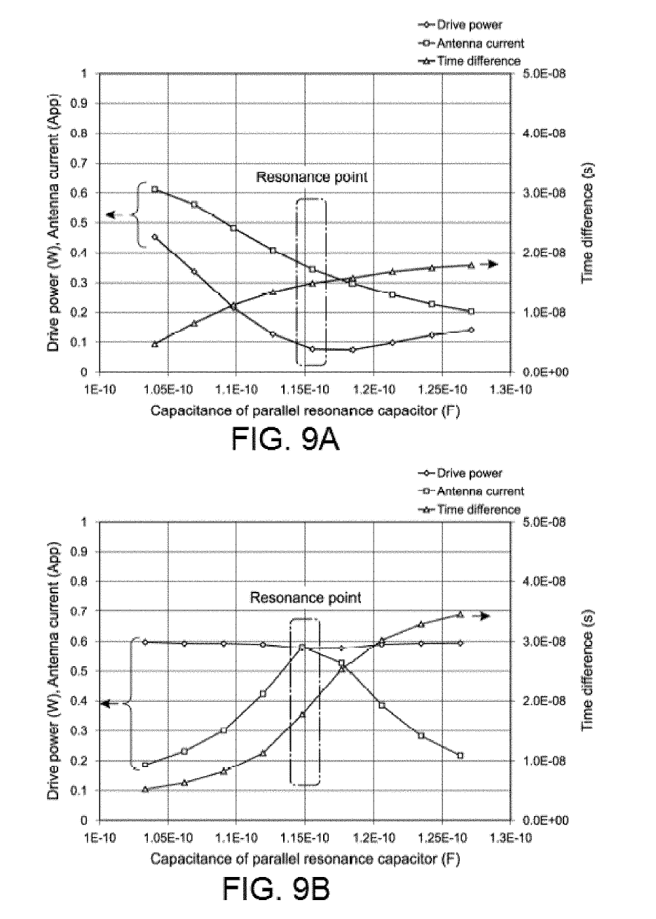

FIG. 9A is a graph showing a relationship among the capacity Cp, the drive power, the antenna current, and the time difference for the transmission apparatus 10A. Here, the drive power is electric power supplied to the antenna drive unit (LSI unit 330), and effective values (or mean values) are shown in the graph.

FIG. 9B is a graph showing a relationship among the capacity Cp, the drive power, the antenna current, and the time difference for the transmission apparatus 10B. Here, the drive power is electric power supplied to the booster, and effective values (or mean values) are shown in the graph.

As shown in FIG. 9A, as the capacitance Cp increases (resonance frequency decreases), the time difference increases, and the antenna current decreases. It can be seen that the drive power is minimized under the resonance condition of Cp=116 pF. In other words, under the resonance condition, the antenna current can be driven most efficiently. The reason why the antenna current decreases when the capacitance Cp becomes large is that the impedance Z becomes larger than 80Ω due to a deviation of the resonance frequency.

As shown in FIG. 9B, as the capacitance Cp increases (resonance frequency decreases), the time difference increases similar to FIG. 9A, but the antenna current becomes maximum under the resonance condition of Cp=115 pF. In this case, it can be seen that the drive power is minimum.

Although the drive voltages differ for the transmission apparatuses 10A and 10B, the voltages both become constant. Therefore, the drive power can also be measured by detecting the drive current.

It can be understood from the descriptions above that by adjusting the time difference to an optimal value (optimal time difference) or by minimizing the drive power (or drive current), automatic tuning of the resonance frequency can be performed irrespective of the presence/absence of the booster 170. Hereinafter, the former tuning method will be referred to as optimal time difference method, and the latter tuning method will be referred to as minimum drive power method. The specific tuning methods will be described later in detail.

The tuning mainly involves detecting an optimal value (optimal control value) of the control signal input to the variable capacitor VC1 for appropriately controlling the resonance frequency. The optimal control value fluctuates according to an environment where the transmission apparatuses 10A and 10B are used. Therefore, detection of the optimal control value in accordance with the environment leads to appropriate control of the resonance frequency of the antenna, to thus obtain stable communication characteristics.

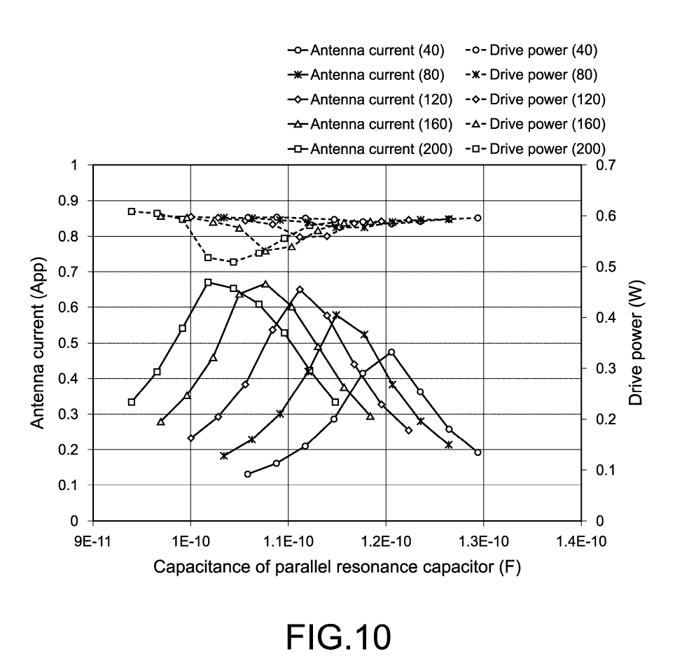

FIG. 10 is a graph showing a relationship among the capacitance Cp, the antenna current, and the drive power for matching impedances of various values in the transmission apparatus 10B. In the graph, the solid lines indicate the antenna current, and the broken lines indicate the drive power. Values in parentheses each represent the matching impedance (a). Specifically, the matching impedance was set to 40, 80, 120, 160, and 200 a. In addition, the inductance of the antenna coil L1 was set to 2 μH.

In order to change the matching impedance while maintaining the resonance condition, it is necessary to change the capacitance of both the series resonance capacitor and the parallel resonance capacitor. In this embodiment, the capacitance of the series resonance capacitor is optimized and fixed by the respective matching impedances.

Regardless of the matching impedance, the antenna current becomes maximum under the resonance condition, and the drive power corresponding to the capacitance Cp in a case where the antenna current is maximum substantially matches with a minimum value. Even when the matching impedance is changed, the fact that the capacitance Cp in the case of the minimum drive power is a capacitance corresponding to the resonance frequency does not change. Therefore, the minimum drive power method includes a merit that there is no need to consider the matching impedance as compared with the optimal time difference method.

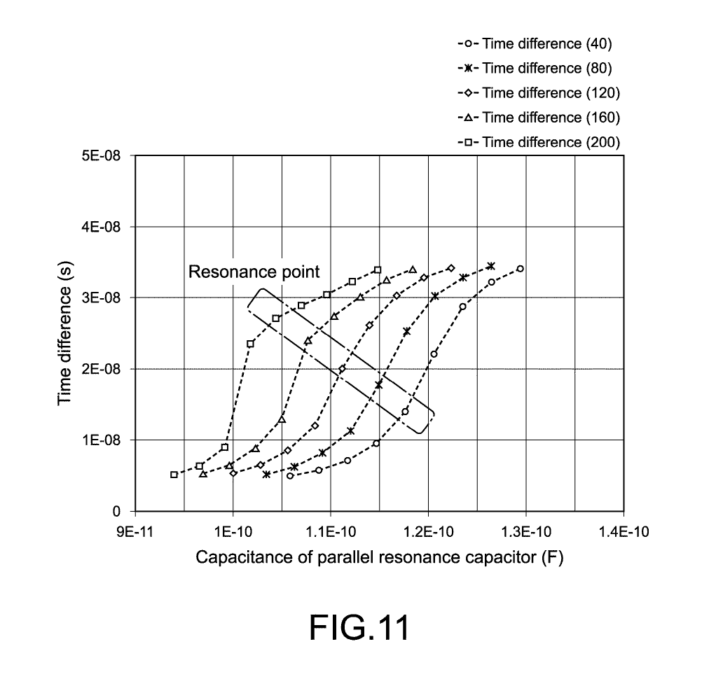

FIG. 11 is a graph showing a relationship between the capacitance Cp and the time difference for the matching impedances of various values in the transmission apparatus 10B. The matching impedance and the setting value of the antenna coil L1 are the same as in the case of FIG. 10. As the matching impedance increases, the time difference under the resonance condition increases. Therefore, it is necessary to change an optimal time difference, that is, an optimal phase difference, for each matching impedance.

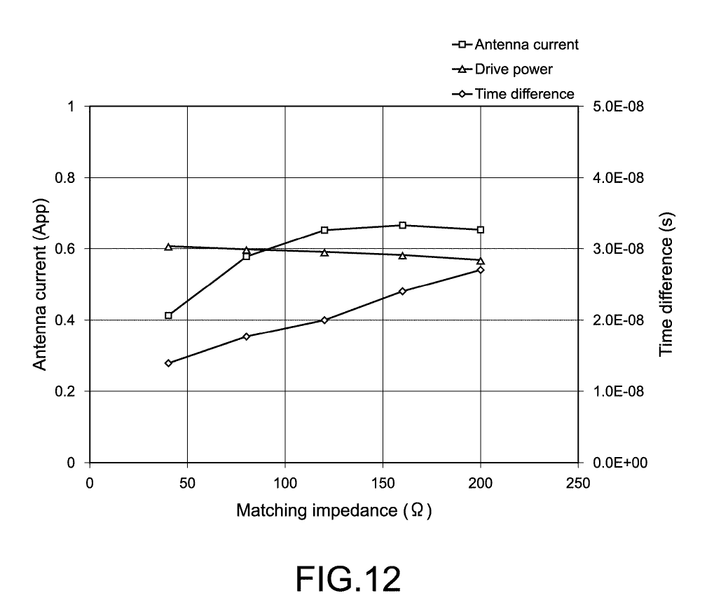

FIG. 12 is a graph showing a relationship among the matching impedance, the antenna current, the time difference, and the drive power in the transmission apparatus 10B. The setting value of the antenna coil L1 is the same as in the case of FIGS. 10 and 11.

Although the antenna current increases as the matching impedance increases, it reaches a peak at 160Ω and decreases a little at 200Ω. In contrast, the time difference monotonically increases, and the drive power monotonically decreases. Thus, both of them can be regarded substantially as straight lines.

An output impedance of (drive unit of) the booster 170 is determined by the inductance of the coils L5 and L6. Therefore, it is considered that the reason why the antenna current under the resonance condition has its peak is because of the impedance matching with this inductance (1.5 μH).

Since the impedance of the coils L5 and L6 at the resonance frequency of 13.56 MHz is about 130Ω, the current becomes the maximum in the vicinity thereof. For example, the impedance of the coil L5 is calculated by [2πf(=13.56 MHz)*inductance value L5]. Since a magnitude of a back electromotive force (magnitude of effect of booster 170) by ON/OFF of the transistors Q1 and Q2 is determined by the inductance of the coils L5 and L6, it is only necessary to perform optimal design in consideration of a balance with the output impedance.

It can be seen from FIG. 12 that in the transmission apparatus including the booster 170, a large antenna current can be obtained with less drive power by setting the matching impedance high. Therefore, the transmission apparatus including the booster 170 becomes useful in a battery-driven apparatus.

### 4. Tuning Method

Hereinafter, the tuning method of the resonance frequency executed by the transmission apparatuses 100A and 100B shown in FIG. 1 or 2 will be described.

### 4.1) Minimum Drive Power Method

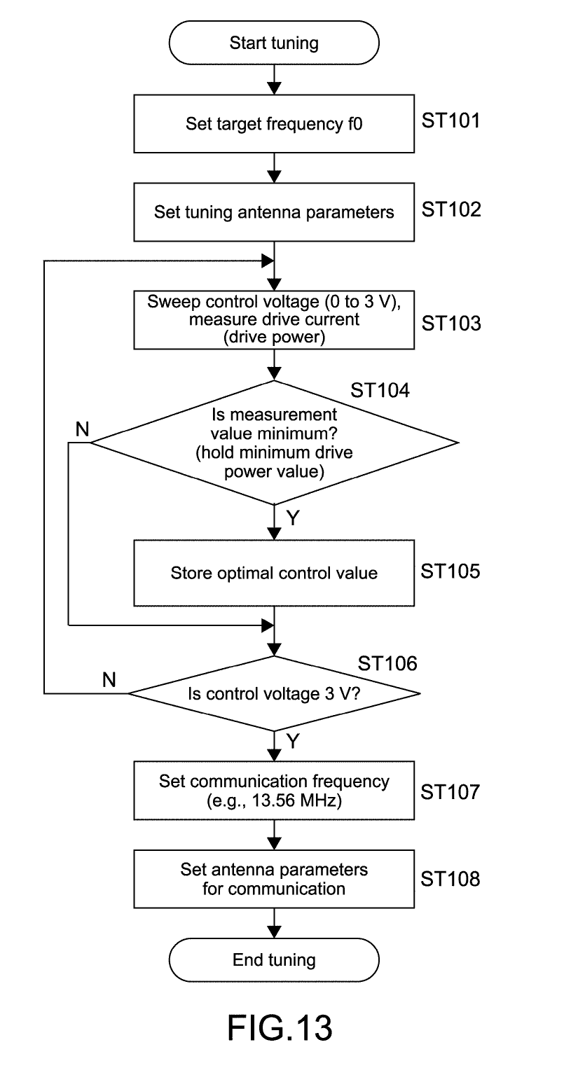

FIG. 13 is a flowchart showing the tuning method that uses the minimum drive power method. This minimum drive power method is a method that can be applied to both of the transmission apparatuses 100A and 100B.

The control unit 140 reads out a target frequency f0 from the storage unit 145 and sets it in the oscillation unit 131 (Step 101). Further, the control unit 140 sets the antenna parameters stored in advance in the storage unit 145 in an internal register of the control unit 140, the gain controller 132, and the like (Step 102).

The antenna parameters are, for example, an impedance, a Q value, a gain of an oscillation signal output from the oscillation unit 131, a control voltage value of the DAC 136 as a control signal to the variable capacitor VC1 (e.g., 0 V as initial value), and the like.

In Steps 103 to 106, the control unit 140 executes processing for detecting an optimal control value.

For example, the control unit 140 sweeps the control voltage as a control signal within a predetermined search range (e.g., 0 to 3 V). Specifically, the control unit 140 increases the control voltage value with respect to the DAC 136 stepwise from 0 V, for example, for each unit voltage, measures the drive current by the detection unit 106 for each step, and calculates the drive power (Step 103). In this case, the control unit 140 functions as an acquisition unit that acquires the drive power value.

The control unit 140 increases the control voltage value up to 3 V which is a maximum value of the system voltage (until measurement is completed). When detecting a minimum value of the drive power within the range of 0 to 3 V (Step 106) (YES in Step 104), the control unit 140 stores an optimal control value as a control voltage value with respect to the DAC 136 at a time the drive power becomes minimum, in the storage unit 145 (Step 105). It is also possible to store a measured minimum drive power value in Step 105.

Specifically, in Step 103, the control unit 140 only needs to compare a previously-measured value with the currently-measured value and hold, in a case where the currently-measured value is smaller than the previously-measured value, that value.

In Step 103, the control unit 140 may acquire a measured drive current value and detect a minimum drive current in Step 104 instead of calculating the drive power. In this case, the control unit 140 or the ADC 134 functions as an acquisition unit that acquires the drive current value. Then, in Step 105, the control unit 140 stores an optimal control value as a control voltage value with respect to the DAC 136 at a time the drive current becomes minimum, in the storage unit 145.

After increasing the control voltage value up to 3 V (Yes in Step 106), the control unit 140 sets a normal oscillation frequency for communication (e.g., 13.56 MHz) in the oscillation unit 131 (Step 107). The control unit 140 sets the antenna parameters for communication (Step 108) and ends the tuning processing. As one of the antenna parameters for communication, there is the optimal control value stored in the storage unit 145. In other words, during communication, the control unit 140 controls the resonance frequency using the optimal control value stored in the storage unit 145.

### 4.2) Optimal Time Difference Method

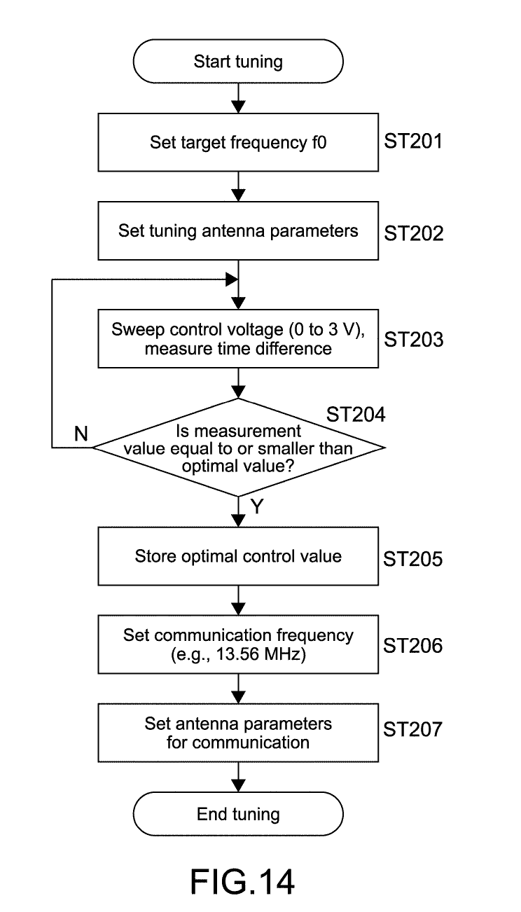

FIG. 14 is a flowchart showing the tuning method that uses the optimal time difference method. This optimal time difference method is a method that can be applied to both of the transmission apparatuses 100A and 100B. In this flowchart, descriptions on steps similar to those shown in FIG. 13 will be omitted.

In Step 202, the control unit 140 extracts an optimal time difference stored in the storage unit 145 and sets it as one of the antenna parameters. The optimal time difference only needs to be stored in the storage unit 145 at a time of factory shipment (at time of manufacturing) of the transmission apparatuses 100A and 100B. The optimal time difference may be calibrated or updated at an arbitrary or predetermined timing after factory shipment.

In Step 203, for example, the control unit 140 sweeps the control voltage as a control signal within a predetermined search range (e.g., 0 to 3 V). Specifically, the control unit 140 increases the value stepwise from 0 V for each unit voltage, and the measurement unit 105 measures the time difference between the drive pulse (transmission signal) and the antenna current for each step (Step 203). The control unit 140 acquires the measured time difference, and in this case functions as the acquisition unit.

In a case where the measured time difference is equal to or smaller than the set optimal time difference (Yes in Step 204), the control unit 140 sets that measured time difference as the optimal time difference. Then, the control unit 140 stores the optimal control value as the control voltage value with respect to the DAC 136 at a time the optimal time difference is detected, in the storage unit 145 (Step 205).

In the flowchart of the minimum drive power method shown in FIG. 13, it is necessary to search all of the control voltage values of 0 to 3 V. However, in this optimal time difference method, there is no need to search all of the control voltage values (predetermined search range) of 0 to 3 V, and it is possible to end the search at a time point the optimal time difference is detected in Steps 203 and 204.

At the time of setting the antenna parameters for communication in Step 108, the control unit 140 sets the optimal control value stored in Step 205 as one of the antenna parameters (Step 208).

### 5. Conclusion

As described above, in the minimum drive power method, the resonance frequency is controlled such that the drive current or the drive power based on that drive current thereof becomes minimum. Therefore, it is possible to appropriately control the resonance frequency of the antenna in accordance with a fluctuation of the environment where the transmission apparatuses 100A and 100B are used irrespective of the presence/absence of the booster 170, and thus obtain stable communication characteristics.

Further, since the minimum drive power method does not involve the matching impedance, the design becomes easy.

On the other hand, in the optimal time difference method, the resonance frequency is controlled such that the drive current or the drive power based on that drive current becomes minimum by using the optimal time difference between the transmission signal and the antenna current that has been stored in advance. Therefore, similar to the case described above, it is possible to appropriately control the resonance frequency of the antenna in accordance with a fluctuation of the environment where the transmission apparatus is used irrespective of the presence/absence of the booster 170, and thus obtain stable communication characteristics.

In this embodiment, the same control method can be used irrespective of the presence/absence of the booster 170, that is, in both the transmission apparatuses 100A and 100B. Therefore, the application range becomes wide, and there is also a merit in terms of costs. While there is a need to arrange an antenna in a memory card for performing communication by NFC, there are cases where an antenna having a size smaller than an outer shape of the memory card is mounted. Radio waves emitted because of the compact size as antenna characteristics become weak, and thus the use of small antennas is disadvantageous from a viewpoint of communication. Since it is difficult to downsize the booster to raise the weak radio field intensity, it becomes difficult to arrange the booster in the memory card. According to the present technology, it is possible to select one of the transmission apparatus 100A not including the booster 170 and the transmission apparatus 100B including the booster 170 in accordance with a size of an apparatus, and incorporate it into the apparatus.

### 6. Non-Contact Power Feeding (Wireless Power Feeding) System

The technology of the non-contact communication system 1 (see FIG. 1) can be applied to WPC (Wireless Power Consortium) or the like which is a technology of the non-contact power feeding system.

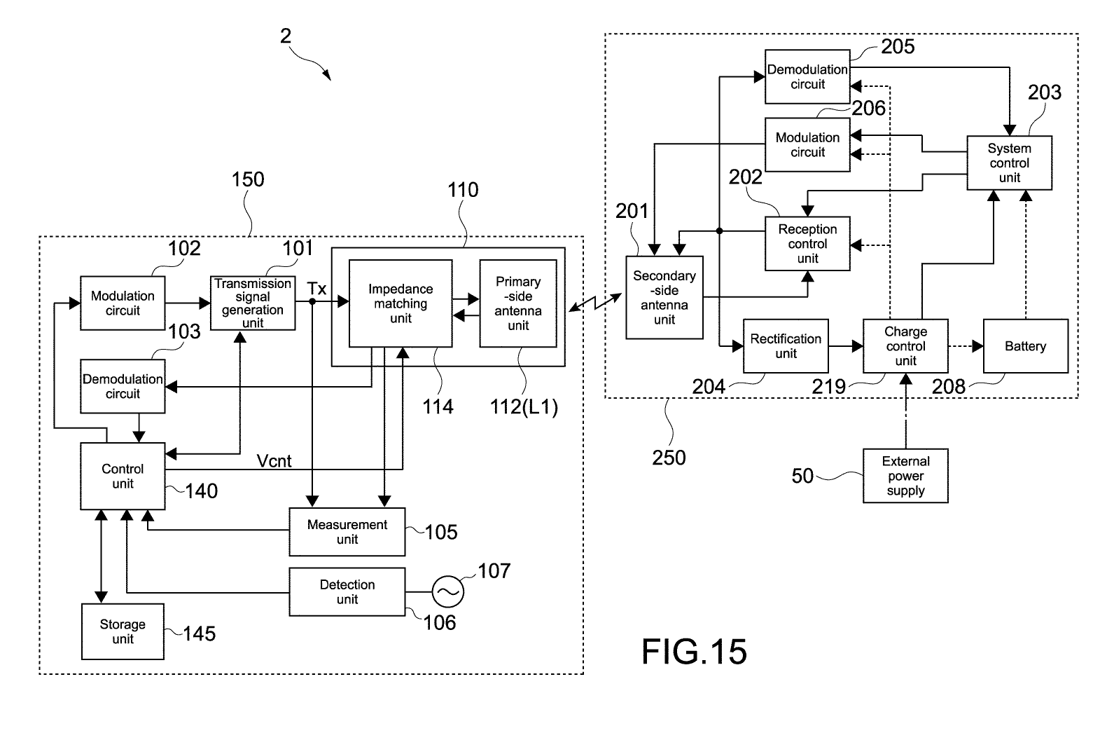

FIG. 15 is a block diagram showing a configuration of the non-contact power feeding system. A difference between this non-contact power feeding system 2 and the non-contact communication system 1 shown in FIG. 1 is that a power feeding mode is provided, and a charge control unit 219 is provided in a power reception apparatus 250. Here, a system corresponding to bidirectional communication for transmission/reception is shown.

The antenna resonance unit 110 of a power feeding apparatus (transmission apparatus) 150 is constituted of an LC resonance circuit and has an output frequency of 100 to 200 kHz in an electromagnetic induction system known as a Qi format, for example. In a case where the system allows a plurality of systems as the format as described above, the oscillation frequency used by the LSI (antenna drive unit) and the specification of the antenna coil L1 in the antenna resonance unit 110 become different.

As a power feeding system of this non-contact power feeding system 2, systems of electromagnetic induction, magnetic field resonance, and the like are applicable, though not limited thereto. The power feeding apparatus 150 transmits a carrier signal and causes a current to flow to the antenna via the primary-side antenna unit 112. A magnetic field generated by the current flowing through the antenna coil is magnetically coupled with the secondary-side antenna unit 201 of the power reception apparatus 250, whereby the voltage is excited by the secondary-side antenna unit 201 and energy transmission is performed.

In a communication state of the non-contact communication system 1, a communication distance between the transmission apparatus 100 and the reception apparatus 200 is long, and the distance changes. However, in the electromagnetic induction system known as the Qi format as the power feeding system, for example, since the power reception apparatus 250 (e.g., cellular phone device) is placed on the power feeding apparatus 150 (e.g., power feeding transmission pad), the distance between the apparatuses always becomes substantially constant. In such a non-contact power feeding system 2, a resonance circuit is provided in each of the power feeding apparatus 150 and the power reception apparatus 250, and the problems of the positional deviation or the deviation of the resonance frequency due to an apparatus to which power is fed are the same as those of the non-contact communication system 1 (solved by non-contact communication system 1).

Specifically, the primary-side antenna unit 112 and the secondary-side antenna unit 201 are each constituted of a resonance circuit so as to resonate at a carrier frequency for performing efficient transmission. Generally, energy efficiency is determined by multiplying a coupling coefficient k of electromagnetic induction coupling and the Q value of the antenna. Therefore, it is desirable for k to be large and Q to be high. However, when Q of the resonance circuit is set high, the resonance frequency largely deviates due to a variance in the constant, so it is necessary to use a component with extremely high accuracy or adjust the resonance frequency as described above.

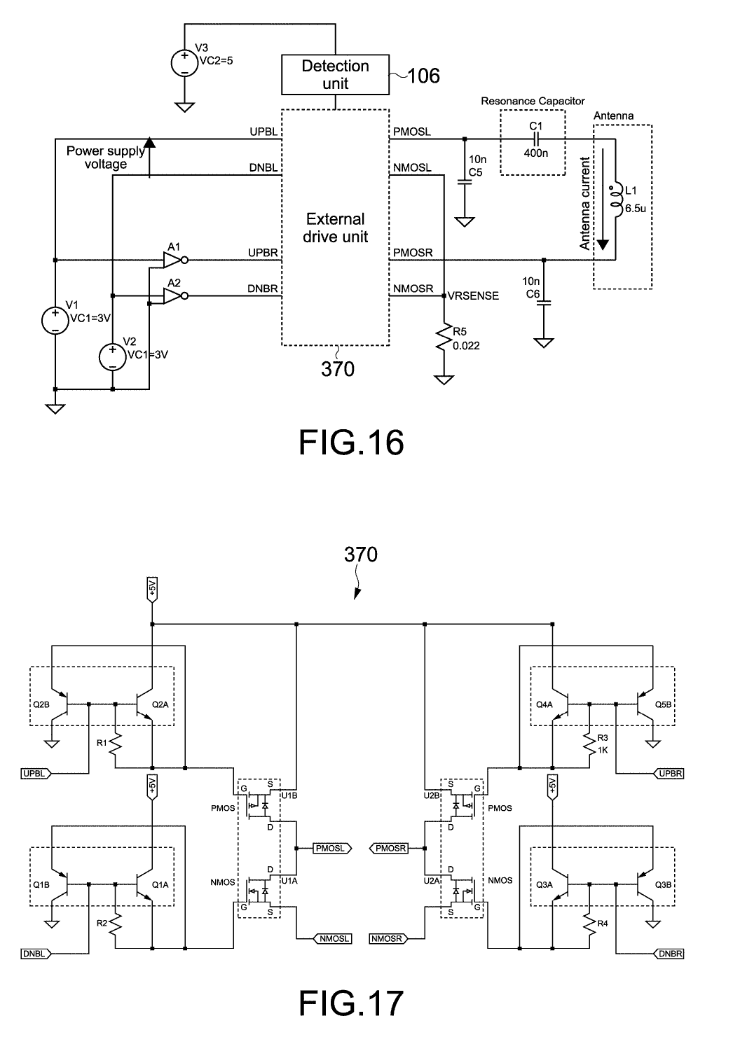

FIG. 16 shows a circuit configuration of the power feeding apparatus 150 including an external drive unit. FIG. 17 shows a configuration of that external drive unit 370. The external drive unit 370 is configured as a full bridge circuit. As shown in FIG. 16, the detection unit 106 is configured to detect electric power (current) supplied to the external drive unit 370.

The technology of the transmission apparatus described above is also applicable to the power feeding apparatus of the non-contact power feeding system. Specifically, by applying the minimum drive power method or the optimal time difference method irrespective of the presence/absence of the external drive unit, it becomes possible to appropriately control the resonance frequency of the antenna in accordance with a fluctuation of the environment where the power feeding apparatus is used, and obtain stable communication characteristics.

### 7. Various Other Embodiments

The present invention is not limited to the embodiments described above, and various other embodiments can be realized.

In the transmission apparatus 100A shown in FIG. 2, for example, a signal from the differential amplifier A2 may be input as the transmission signal to the non-inverting input terminal of the phase comparator A3, and a signal of the antenna current based on that transmission signal may be input to the inverting input terminal.

Similarly, in the transmission apparatus 100B shown in FIG. 3, a signal from the differential amplifier A2 may be input as the transmission signal to the non-inverting input terminal of the phase comparator A3, and a signal of the antenna current based on the transmission signal from the differential amplifier A1 may be input to the inverting input terminal.

In the transmission apparatuses 100A and 100B, in a case where the tuning is executed using only the minimum drive power method without using the optimal time difference method, the measurement unit 105 does not need to be provided.

Conversely, in the transmission apparatuses 100A and 100B, in a case where the tuning is executed using only the optimal time difference method without using the minimum drive power method, the detection unit 106 does not need to be provided.

At least two of the feature portions according to the embodiments described above can be combined.

### REFERENCE SIGNS LIST

A1, A2 pair of differential amplifiers
L1 antenna coil L1
VC1 variable capacitance capacitor
100 transmission apparatus
100A transmission apparatus (not including booster)
100B transmission apparatus (including booster)
105 measurement unit
106 detection unit
110 antenna resonance unit
114 impedance matching section
130 antenna drive unit
131 oscillation unit
135 pulse generation unit
140 control unit
145 storage unit
150 power feeding apparatus
170 booster (external drive unit)
370 external drive unit

1. A transmission apparatus, comprising:
an antenna resonance unit including an antenna coil and an impedance matching unit;
a drive unit that generates a transmission signal with respect to the antenna resonance unit;
a detection unit that detects a drive current or drive power for operating the drive unit; and
a control unit that is capable of generating a control signal for controlling the impedance matching unit, and controls a resonance frequency of the antenna resonance unit using, out of the control signal, an optimal control value with which the drive current or drive power detected by the detection unit becomes minimum.

2. The transmission apparatus according to claim 1, wherein
the control unit detects the optimal control value by outputting the control signal within a predetermined search range.

3. The transmission apparatus according to claim 1, wherein
the detection unit outputs a mean value or effective value of the drive current.

4. The transmission apparatus according to claim 1, further comprising
a storage unit that stores an optimal time difference between the transmission signal and an antenna current flowing through the antenna coil, the optimal time difference being an optimal time difference corresponding to a controlled amount of the impedance matching unit at a time the drive current or drive power becomes minimum.

5. The transmission apparatus according to claim 4, further comprising
a measurement unit that measures a time difference between the transmission signal and the antenna current flowing through the antenna coil.

6. The transmission apparatus according to claim 5, wherein
the control unit acquires the time difference measured by the measurement unit by outputting the control signal within a predetermined search range, and detects the optimal control value on a basis of a result of a comparison between the measured time difference and the optimal time difference.

7. The transmission apparatus according to claim 5, wherein
the measurement unit includes a phase comparator that compares a phase of the transmission signal that is output from the drive unit and input to the antenna resonance unit and a phase of the antenna current.

8. The transmission apparatus according to claim 7, wherein
the drive unit includes
an oscillation unit, and
a pair of differential amplifiers to which a signal from the oscillation unit is input, the pair of differential amplifiers respectively generating, as the transmission signal, a first signal and a second signal having a phase opposite to that of the first signal, and
the phase comparator compares a phase of the first signal and the phase of the antenna current by the first signal, out of the signals respectively generated by the pair of differential amplifiers.

9. The transmission apparatus according to claim 7, wherein
the drive unit includes
an external drive unit that amplifies the antenna current,
an oscillation unit, and
a pair of differential amplifiers to which a signal from the oscillation unit is input, the pair of differential amplifiers respectively generating, as the transmission signal, a first signal and a second signal having a phase opposite to that of the first signal, and
the phase comparator compares a phase of the first signal and the phase of the antenna current by the second signal, out of the signals respectively generated by the pair of differential amplifiers.

10. The transmission apparatus according to claim 1, wherein
the drive unit includes an external drive unit that amplifies an antenna current.

11. A transmission apparatus, comprising:
an antenna resonance unit including an antenna coil and an impedance matching unit;
a drive unit that generates a transmission signal with respect to the antenna resonance unit;
a measurement unit that measures time differences between the transmission signal and an antenna current flowing through the antenna coil; and
a control unit that is capable of generating a control signal for controlling the impedance matching unit, and controls a resonance frequency of the antenna resonance unit using, out of the control signal, an optimal control value corresponding to an optimal time difference at a time a drive current or drive power for operating the drive unit becomes minimum, out of the time differences measured by the measurement unit.

12. An antenna drive apparatus that drives an antenna resonance unit including an antenna coil and an impedance matching unit, the antenna drive apparatus comprising:
a generation unit that generates a transmission signal with respect to the antenna resonance unit;
an acquisition unit that acquires a value of a drive current detected by a detection unit that detects a drive current or drive power for operating a drive unit; and
a control unit that is capable of generating a control signal for controlling the impedance matching unit, and controls a resonance frequency of the antenna resonance unit using, out of the control signal, an optimal control value with which the drive current or drive power detected by the detection unit becomes minimum.

13. An antenna drive apparatus that drives an antenna resonance unit including an antenna coil and an impedance matching unit, the antenna drive apparatus comprising:
a generation unit that generates a transmission signal with respect to the antenna resonance unit;
an acquisition unit that acquires a time difference measured by a measurement unit that measures time differences between the transmission signal and an antenna current flowing through the antenna coil; and
a control unit that is capable of generating a control signal for controlling the impedance matching unit, and controls a resonance frequency of the antenna resonance unit using, out of the control signal, an optimal control value corresponding to an optimal time difference at a time a drive current or drive power for operating a drive unit becomes minimum, out of the time differences measured by the measurement unit.

14. A tuning method executed by a transmission apparatus including an antenna resonance unit including an antenna coil and an impedance matching unit and a drive unit that generates a transmission signal with respect to the antenna resonance unit, the tuning method being a method of tuning a resonance frequency of the antenna resonance unit, the method comprising:
outputting a control signal for controlling the impedance matching unit; and
detecting a drive current or drive power for operating the drive unit in accordance with the output of the control signal, to detect, out of the control signal, an optimal control value with which the drive current or drive power becomes minimum.

15. A tuning method executed by a transmission apparatus including an antenna resonance unit including an antenna coil and an impedance matching unit and a drive unit that generates a transmission signal with respect to the antenna resonance unit, the tuning method being a method of tuning a resonance frequency of the antenna resonance unit, the method comprising:
outputting a control signal for controlling the impedance matching unit;
measuring time differences between the transmission signal and an antenna current flowing through the antenna coil in accordance with the output of the control signal; and
comparing the measured time difference and an optimal time difference between the transmission signal and an antenna current flowing through the antenna coil, the optimal time difference being an optimal time difference corresponding to a controlled amount of the impedance matching unit at a time a drive current or drive power for operating the drive unit becomes minimum, to detect, out of the control signal, an optimal control value with which the drive current or drive power becomes minimum.

16. A program executed by a transmission apparatus including an antenna resonance unit including an antenna coil and an impedance matching unit and a drive unit that generates a transmission signal with respect to the antenna resonance unit, the program causing the transmission apparatus to execute:
outputting a control signal for controlling the impedance matching unit; and
detecting a drive current or drive power for operating the drive unit in accordance with the output of the control signal, to detect, out of the control signal, an optimal control value with which the drive current or drive power becomes minimum.

17. A program executed by a transmission apparatus including an antenna resonance unit including an antenna coil and an impedance matching unit and a drive unit that generates a transmission signal with respect to the antenna resonance unit, the program causing the transmission apparatus to execute:
outputting a control signal for controlling the impedance matching unit;
measuring time differences between the transmission signal and an antenna current flowing through the antenna coil in accordance with the output of the control signal; and
comparing the measured time difference and an optimal time difference between the transmission signal and an antenna current flowing through the antenna coil, the optimal time difference being an optimal time difference corresponding to a controlled amount of the impedance matching unit at a time a drive current or drive power for operating the drive unit becomes minimum, to detect, out of the control signal, an optimal control value with which the drive current or drive power becomes minimum.

18. The transmission apparatus according to claim 2, wherein
the detection unit outputs a mean value or effective value of the drive current.

19. The transmission apparatus according to claim 6, wherein
the measurement unit includes a phase comparator that compares a phase of the transmission signal that is output from the drive unit and input to the antenna resonance unit and a phase of the antenna current.

20. The transmission apparatus according to claim 19, wherein
the drive unit includes
an oscillation unit, and
a pair of differential amplifiers to which a signal from the oscillation unit is input, the pair of differential amplifiers respectively generating, as the transmission signal, a first signal and a second signal having a phase opposite to that of the first signal, and
the phase comparator compares a phase of the first signal and the phase of the antenna current by the first signal, out of the signals respectively generated by the pair of differential amplifiers.

21. The transmission apparatus according to claim 19, wherein
the drive unit includes
an external drive unit that amplifies the antenna current,
an oscillation unit, and
a pair of differential amplifiers to which a signal from the oscillation unit is input, the pair of differential amplifiers respectively generating, as the transmission signal, a first signal and a second signal having a phase opposite to that of the first signal, and
the phase comparator compares a phase of the first signal and the phase of the antenna current by the second signal, out of the signals respectively generated by the pair of differential amplifiers.
